(19) United States
(12) Patent Application Publication
(10) Pub. No.: US 2026/0177404 A1
(43) Pub. Date: Jun. 25, 2026

(54) METER PIT ASSEMBLY

(71) Applicant: Mueller International, LLC, Atlanta, GA (US)

(72) Inventors: Harold Thomas Mosley, Oolterwah, TN (US); Timothy Bain Ervin, Apison, TX (US); Jordan Blake Kaldenbach, Ooltewah, TN (US); David Cole Canady, West, TX (US); Lawrence Akridge Aulich, Soddy Daisy, TN (US)

(21) Appl. No.: 18/990,428

(22) Filed: Dec. 20, 2024

(51) Int. Cl. G01D 4/02

(52) U.S. Cl. CPC G01D 4/02

(57) ABSTRACT

The present disclosure describes a meter pit assembly featuring a utility inlet connection, a utility outlet connection, a ball valve, a canister check valve, a pressure transducer electronically linked to a logger, a temperature sensor electronically connected to the logger, a sample port equipped with a quick connect fitting, and a coil enabling the relocation of a meter from a lowered to a raised position. This innovative assembly provides efficient and reliable utility usage monitoring, with enhanced functionality and ease of access for maintenance and data collection purposes.

### TECHNICAL FIELD

This disclosure relates to a meter pit assembly. More specifically, this disclosure relates to an integral meter pit assembly comprising water quality ports and logging ports.

### BACKGROUND

Previous approaches to meter pit assemblies have typically involved separate components for utility inlet and outlet connections, ball valves, check valves, pressure transducers, temperature sensors, sample ports, and meter relocation mechanisms. These components are often assembled individually, leading to increased complexity in installation and maintenance. Additionally, the electronic coupling of pressure transducers and temperature sensors to loggers has been achieved through various wiring configurations, which can be cumbersome and prone to errors during setup and operation.

In existing meter pit assemblies, the relocation of a meter from a lowered position to a raised position has been addressed using mechanical designs that may involve manual adjustments or additional components. These designs may lack efficiency and precision in relocating the meter, potentially leading to inaccuracies in meter readings and increased maintenance requirements.

### SUMMARY

It is to be understood that this summary is not an extensive overview of the disclosure.

This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a meter pit assembly including: a utility connection; a ball valve; a sensor electronically coupled to the logger; a sample port including a quick connect fitting; and a coil configured to relocate a meter from a lowered position to a raised position.

In another aspect, disclosed is a meter pit assembly including: a utility connection; a ball valve; a check valve a logger electronically coupled to a sensor; and a sample port including a quick connect fitting.

In yet another aspect, disclosed is a method of collecting data from a meter pit assembly including: installing a meter pit assembly including a ball valve, a sensor electronically coupled to a logger, and a sample port including a quick connect fitting; measuring a parameter of a working fluid, including at least one of a pressure, a temperature, and a flow rate of the working fluid; and electronically transmitting the parameter to a network monitoring the meter pit assembly.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a schematic of a meter pit assembly, in accordance with one aspect of the current disclosure.

FIG. 2 is a perspective view of the meter pit assembly in the lowered configuration with a portion of the sidewall removed.

FIG. 3 is a perspective view of the meter pit assembly of FIG. 2 in the raised configuration.

FIG. 4 is a perspective view of a coil assembly of the meter pit assembly of FIG. 2.

FIG. 5 is an exploded view of the coil assembly of FIG. 4 with the coil removed.

FIG. 6 is a perspective view of a rigid or fixed meter pit assembly, in accordance with another aspect of the current disclosure.

FIG. 7 is a profile view of the meter pit assembly of FIG. 6 with the sidewall and lid removed.

FIG. 8 is an exploded view of FIG. 7.

FIG. 9A is a perspective view of a meter resetter for use with the meter pit assembly of FIG. 2.

FIG. 9B is a perspective view of another meter resetter for use with the meter pit assembly of FIG. 2.

FIG. 10A is a top view of a backflow preventer in use with the meter pit assembly of FIG. 2.

FIG. 10B is a side view of the backflow preventer in use with the meter pit assembly of FIG. 10A.

FIG. 11 is a side view of a pressure reducing valve in use with the meter pit assembly of FIG. 2.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, an integrated meter pit assembly and associated methods, systems, devices, and various apparatuses are disclosed herein. In one aspect, the integrated meter pit assembly comprises inlet and outlet connections for the water line, a ball valve on the inlet side, a canister check valve on the outlet side, a pressure transducer, a temperature sensor, a hydrophone, a flow meter, a sample port, and/or a coil to permit raising and lowering of the meter.

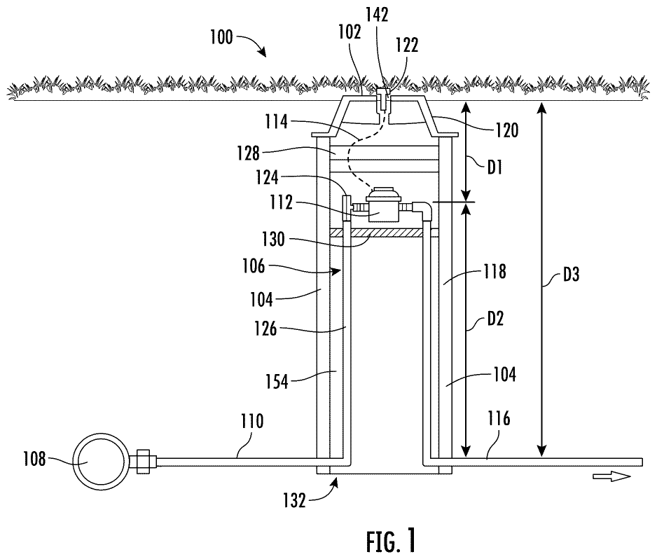

FIG. 1 is a schematic of a meter pit assembly 100. Meter pit assembly 100 can comprise a pit lid or lid 102 and a sidewall 104 supporting the lid 102. The lid 102 can be disposed on, in, and/or over the sidewall 104 to cover utility assembly 106 comprising various piping components configured with water quality components and logging components configured to measure the pressure, temperature, and/or flow of the working fluid. The utility assembly 106 can be connected to a utility main 108 (e.g., water, sewer, gas utility) and can comprise a service line 110 connected to the utility main 108 and traversing a utility meter valve or meter 112, of the utility assembly 106. The sidewall 104 can define an interior 154. A wire 114 can electronically couple to one or more components in the meter pit assembly 100 to transmit electronic signals related to the temperature, flow, and/or pressure of a working fluid being transported through the utility main 108, service line 110, and/or meter 112. In various aspects, the wire 114 can be replaced by wireless communication systems known in the art.

In various aspects, meter 112 can comprise a valve 124. The valve 124 can be an integrated valve. The meter 112 can comprise an integrated diaphragm, ball, gate, knife, or other valve 124. For example, valve 124 can be of any type and can be located upstream and/or downstream from the meter 112. The valve 124 can be located anywhere on the service line 110, stub 116, and/or within sidewall 104 and can be positioned before and/or after meter 112. In various aspects, the valve 124 can be arranged in varying locations. In various aspect, the valve 124 can comprise a check valve. In various aspects, the check valve can be a cannister check valve.

Service line 110 can traverse through meter 112 and can extend through stub 116 to the residential or commercial building to provide a utility service (e.g., water or gas) measured through meter 112. A first distance D1, is defined between the surface of lid 102 to the meter 112, and a second distance D2, can be defined between the meter 112 and the service line 110 and/or stub 116. Measurements to and from the meter 112 can be made to a common point, such as a top of the meter 112, a bottom of the meter 112, or a location of a flow pathway through the meter 112. The total distance D3, e.g., defined as the sum of the first distance D1 and the second distance D2, is defined between the lid 102 at the surface to the service line 110 and/or stub 116.

The meter pit assembly 100 can comprise a pit housing 118, a lid support 120, and the lid 102 seated on the lid support 120 and/or pit housing 118. The sidewall 104 can comprise an antenna 122, and wire 114 can electronically couple the antenna 122 to one or more components of the meter pit assembly 100 (e.g., the meter 112). In various aspects, the wire 114 can be replaced by wireless communication systems known in the art. In various aspects, the meter pit assembly 100 can comprise risers 126 to raise the elevation of the service line 110 and/or insulation plugs 128 to prevent freezing of the service line 110 and/or the meter 112. In various aspects, meter 112 can be supported on a platform 130. As described in greater detail below, platform 130 can be rigid or adjustable. In aspects, the adjustable platform 130 can be locked in a raised position near lid 102, e.g., and lowered when desired (e.g., in a cold environment during winter). Various joints 132 inside and/or outside pit housing 118 can facilitate the coupling of the utility assembly 106 to the service line 110 and/or stub 116. Joints 132 can serve as utility connections in various aspects. One joint 132 can serve as a utility inlet connection and another joint 132 can serve as a utility outlet connection.

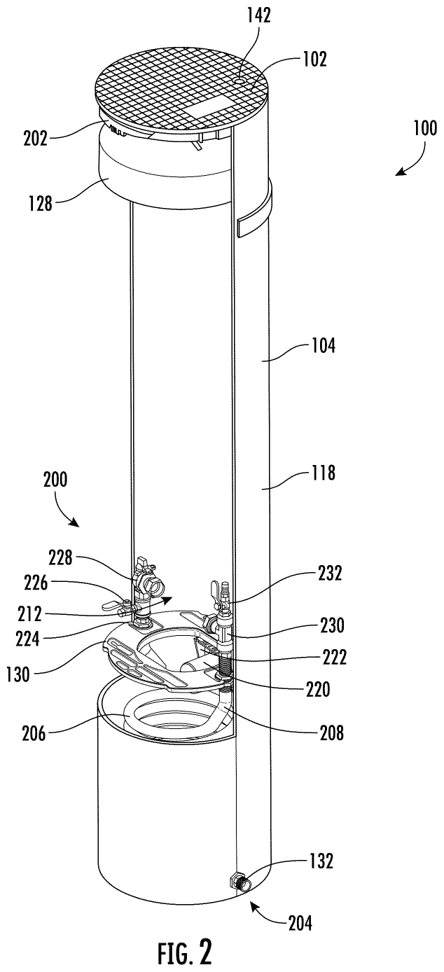

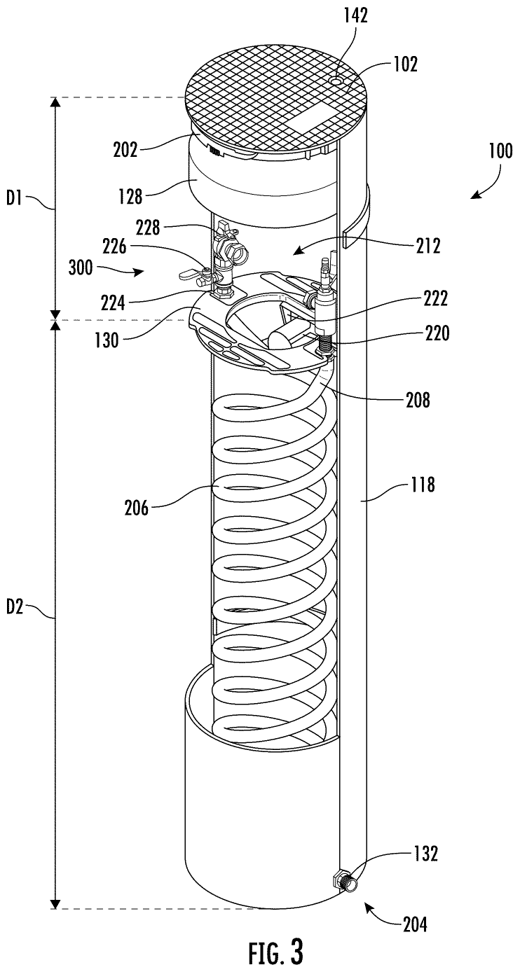

FIG. 2 shows one aspect of meter pit assembly 100 comprising lid 102 and sidewall 104, defining pit housing 118. Insulation plugs 128 near lid 102 can support and/or be adjacent to bracket 202. Various joints 132 can define an inlet or, as shown in FIG. 2, an outlet 204. In various aspects, these joints 132 can be the utility inlet connection and utility outlet connection. A fluid pathway can be defined from the joint 132 serving as the utility inlet connection to coil 206 and to a hose connector 208. The hose connector 208 can be connected as part of meter pit assembly 100 to platform 130 that is movable between a lowered position 200 shown in FIG. 2 and a raised position 300 (shown in FIG. 3). Coil 206 can be flexible and can be configured to rotatably flex and/or to axially flex between a relaxed and lowered position and an elongated raised position. Coil 206 can allow the selective relocation of meter 112 from the lowered position 200 to the raised position 300 and vice versa. In various aspects, the coil 206 can be flexible tubing. The fluid pathway can continue through the meter 112, through any downstream fittings, and to the joint 132 serving as the utility outlet connection. As such, the fluid pathway can provide fluid communication from the utility inlet connection to the utility outlet connection through various valves and features within the meter pit assembly 100.

In various aspects the pit housing 118 can be adjustable in its sizing. Such adjustable pit housing 118 can be understood with reference to the following United States patents, each of which is incorporated by reference herein in its entirety: U.S. Pat. No. 9,032,989 to Floyd, filed Sep. 22, 2009, issued May 19, 2015; U.S. Pat. No. 9,410,838 to Flowing, filed Apr. 2, 2015, issued Aug. 9, 2016; and, U.S. Pat. No. 9,243,944 to Floyd, filed May 1, 2012, issued Jan. 26, 2016.

Platform 130 can be adjustable in the aspect shown in FIGS. 2 and 3, such that platform 130 can move between the lowered position 200 and the raised position 300. In some aspects, platform 130 can be made from and/or comprise ABS plastic or thermoset plastic that can be lightweight and structurally rigid. In various arrangements, platform 130 can be locked into the raised position 300 and prevented from inadvertently returning to the lowered position 200.

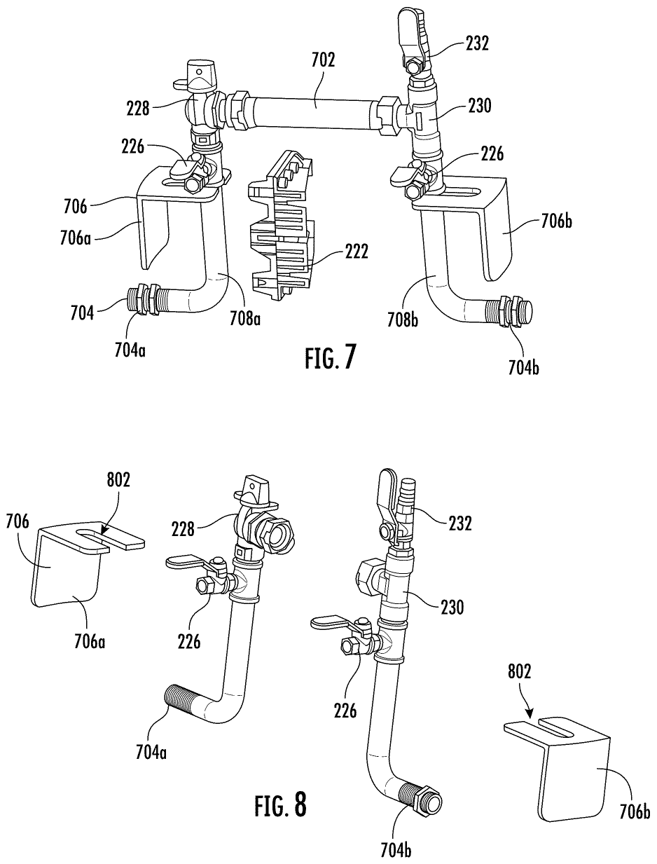

As shown in FIGS. 2 and 3, an absence 212 is shown instead of meter 112 (FIG. 1) because meter 112 can be replaced in various aspects. In various aspects, the meter pit assembly 100 can be supplied with a jumper 702 (FIG. 7). For example, in some aspects, the jumper 702 can provide a secure assembly configured to ship and install meter pit assembly 100. Once installed, the meter 112 can be used to replace the jumper 702 in the meter pit assembly 100. The jumper 702 can also be utilized for testing the system prior to introduction of the meter 112. In various aspects, the meter pit assembly 100 can be used to replace, update, and/or improve current installations of meter 112 to retrofit meter 112 that is not shipped with meter pit assembly 100. Stated differently, absence 212 shows the ability to retrofit and/or install meter 112 into meter pit assembly 100 without requiring a new implementation of meter 112.

A logger 220 can be held by a mounting bracket 222 that can position the logger 220 relative to platform 130. Moving platform 130 from lowered position 200 to raised position 300 can securely move logger 220, and mounting bracket 222 can support logger 220 relative to platform 130.

In some aspects, a hex nut 224 can couple the hose connector 208 to a pipe port 226 coupled to a ball valve 228. Although the ball valve 228 is generally referenced as a “ball valve” in the current disclosure, one of skill in the art would understand that a variety of valves can be utilized without departing from the scope of the disclosure. In various aspects, pipe port 226 can serve as a sample port. Ball valve 228 can be configured to couple to a probe, e.g., to measure the temperature, flow, and/or pressure of the working fluid in hose connector 208. For example, a sensor, such as a water temperature probe, a hydrophone, a water flow meter, and/or a water pressure transducer, can be installed at pipe port 226 if the working fluid is water. Each sensor can be selected from the group comprising a pressure transducer, a hydrophone, a temperature sensor, a flow meter such as meter 112, and/or other sensors known in the art. In various aspects, each sensor can be capable of wireless communication, such as with the logger 220. In some aspects, the hydrophone is a specific type of pressure transducer. Similar configurations for gas (e.g., compressible fluids such as air, nitrogen, oxygen, methane, natural gas, etc.) and liquids (e.g., incompressible fluids like water, oil, and gasoline/petroleum) are contemplated. The pipe port 226 provides a convenient location to insert a probe to measure and/or electronically couple logger 220 to a working fluid parameter within hose connector 208.

On the side opposite meter 112, a meter coupling tee 230 can comprise a quick connect 232 on the first side of meter coupling tee 230 and can connect to coil 206 on the opposite side of meter coupling tee 230. The quick connect 232 can serve as a sample port in various aspects. Coil 206 can be fluidly coupled to outlet 204 to communicate the working fluid from meter pit assembly 100 to stub 116.

FIG. 3 shows a partially removed pit housing 118 with platform 130 in a raised position 300. In the configuration of FIG. 3, platform 130 can be locked to prevent movement of meter 112 relative to lid 102. That is, the first distance D1 in the raised position 300 can be significantly less than the first distance D1 in the lowered position 200. Similarly, the second distance D2 in raised position 300 can be greater than the second distance D2 in the lowered position 200. However, regardless of the location of meter 112 the total distance D3 as measured between the surface of lid 102 to the service line 110 and/or stub 116 remains unchanged. As seen with specific reference to FIG. 3, the lid 102 can define a sampling void 142 to allow access to the quick connect 232 from outside of the meter pit assembly 100. A sampling wand can be utilized to attach to the quick connect 232 to sample working fluid.

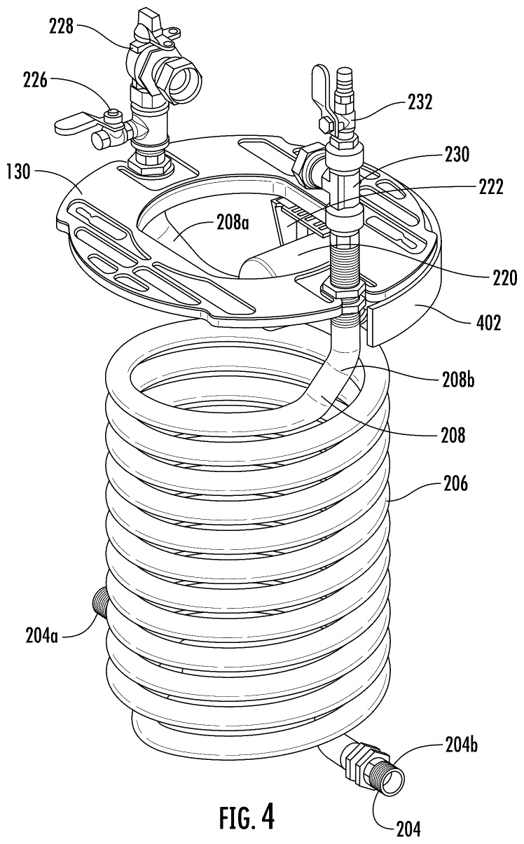

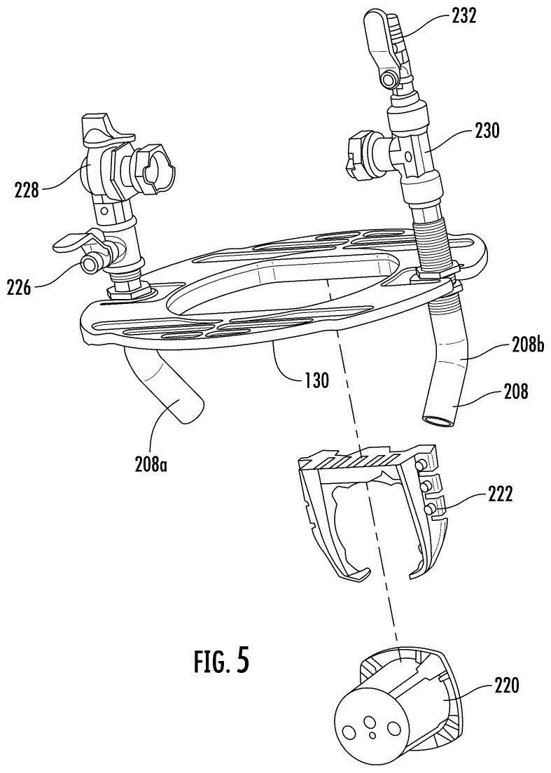

FIG. 4 shows coil 206 and platform 130 with the pit housing 118 removed to illustrate a support bracket 402 configured to lock platform 130 in raised position 300, as shown in FIG. 3. FIG. 5 shows an exploded view of FIG. 4 to isolate the hose connector 208, logger 220, and mounting bracket 222. Platform 130 and pit housing 118 can facilitate the installation of logger 220 in bracket 222 on platform 130. In various aspects, meter pit assembly 100 can comprise a pipe port 226, ball valve 228, meter coupling tee 230, and quick connect 232 on a single platform 130 having an inlet hose connector 208a and an outlet hose connector 208b on a single movable platform 130.

Logger 220 can be any suitable component configured to measure the utility network. For example, logger 220 can be a i2O Water logger technology or an intelligent utility network solution. Logger 220 can be designed to enhance the efficiency and sustainability of utilities, such as gas and water utilities. Logger 220 can be a compact and/or durable device and can be strategically disposed of and/or deployed in pit housing 118. Logger 220 can be deployed throughout water networks to monitor critical parameters such as flow rates, pressure levels, and temperature with high accuracy and granularity. Logger 220 can be an independent, standalone unit and can comprise a battery. For example, a battery-powered logger 220 can facilitate a low power draw and long battery life. In some aspects, Logger 220 can be continuously powered by a power supply. In various aspects, logger 220 can be connected to a source of power such as a solar generator or another type of energy harvester. Wired and/or wireless communication capabilities can be implemented in the logger 220 and can facilitate real-time data transmission to utility control centers, feeding into a proprietary software suite for advanced analysis and visualization.

The data collected by logger 220 can facilitate optimized pressure management dynamically, reduce water loss, minimize energy consumption, and/or extend the lifespan of system infrastructure. Additionally, loggers 220 can support proactive leak detection, allowing early identification and resolution of anomalies, which can help reduce operational costs and improve service reliability. The insights provided by these loggers 220 can enable utilities (e.g., gas and/or water) to prioritize maintenance efforts and/or to make data-driven decisions for additional new installations and/or maintenance of aging utilities. The logger 220 can foster sustainable practices in water distribution, for example, by addressing challenges like aging infrastructure and water scarcity. The logger 220 technology can also help utilities efficiently meet modern environmental and operational goals.

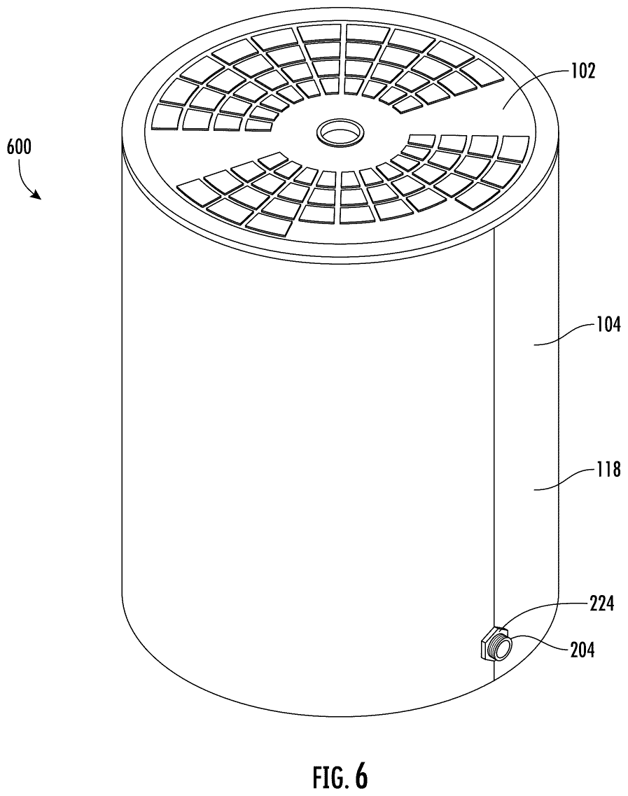

FIG. 6 is a perspective view of a rigid meter pit assembly 600. As shown in FIG. 6, lid 102 and sidewall 104 can support meter 112 (FIG. 1) in a rigid configuration with a fixed outlet 204. Rigid meter pit assembly 600 is substantially the same as or similar to the flexible and/or adjustable meter pit assembly 100, described above, except that the rigid meter pit assembly 600 is fixed. One of skill in the art would understand that descriptions related to meter pit assembly 100 above apply to the aspect of rigid meter pit assembly 600 unless noted otherwise.

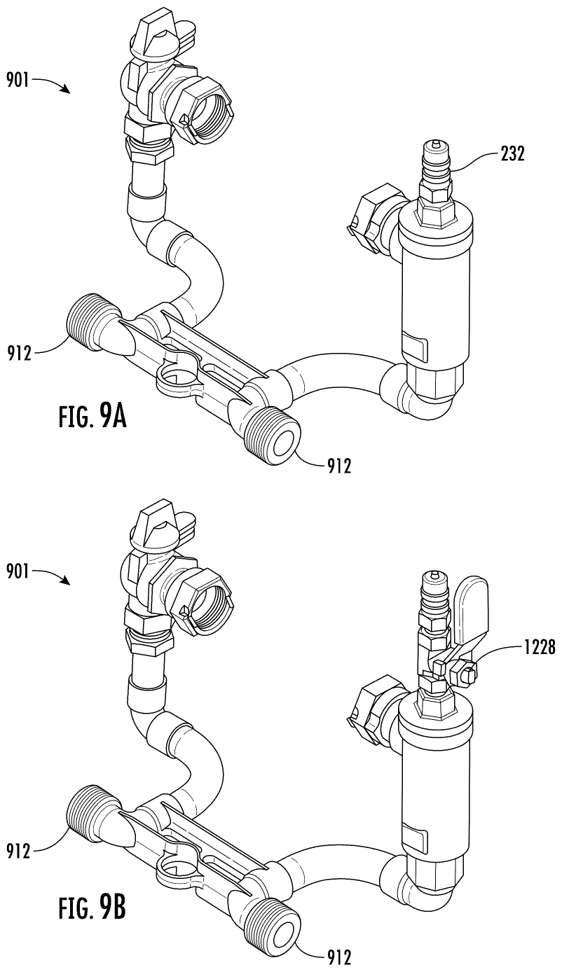

FIGS. 7 and 8 show configurations related to the meter pit assembly 600 of FIG. 6 with the lid 102 and sidewall 104 removed. Similar to the adjustable meter pit assembly 100 shown and described above, rigid meter pit assembly 600 can comprise a meter 112. FIG. 7 shows a jumper 702 that can be configured to couple ball valve 228 to meter coupling tee 230, e.g., during shipping, installation, and/or testing of rigid meter pit assembly 600. Jumper 702 can be removed and replaced with meter 112 once the rigid meter pit assembly 600 is installed in the ground. Jumper 702 and meter 112 can be interchangeable to facilitate installation, maintenance, and/or metered and non-metered use of utility.

Rigid meter pit assembly 600 can comprise hex fittings 704. Specifically, rigid meter pit assembly 600 can comprise an inlet hex fitting 704a and an outlet hex fitting 704b. Hex fittings 704 can be configured to couple to pit housing 118 and secure meter 112 within rigid meter pit assembly 600. Similarly, mounting bracket 222 can be configured to mount logger 220 to the inner side of pit housing 118. In various aspects, mounting bracket 222 can secure logger 220 to other components within rigid meter pit assembly 600.

One or more mounting brackets 706 can be installed to support an inlet riser 708a and an outlet riser 708b. Risers 708 can be the same or substantially similar to the hose connector 208 described above. Inlet riser 708a can couple to pipe port 226 and/or ball valve 228. Ball valve 228 can be configured with a removable coupling to jumper 702 and/or meter 112. Similarly, jumper 702 and/or meter 112 can be coupled to meter coupling tee 230 on the outlet riser 708b. In various aspects, the ball valve 228 can be located on outlet riser 708b, and quick connect 232 on inlet riser 708a.

The outlet riser 708b can comprise a meter coupling tee 230 coupled to quick connect 232 and pipe port 226. Pipe port 226 can be coupled to outlet riser 708b and outlet hex fitting 704b. Coupling inlet hex fitting 704a to pit housing 118 can secure inlet riser 708a to pit housing 118, and coupling outlet hex fitting 704b to pit housing 118 can secure the outlet riser 708b to rigid meter pit assembly 600.

FIG. 8 shows a slot 802 defined in the mounting bracket 706 that can be configured to receive and to support one or more of pipe port 226 on risers 708. This configuration can secure meter 112 when jumper 702 is removed and meter 112 is installed in rigid meter pit assembly 600.

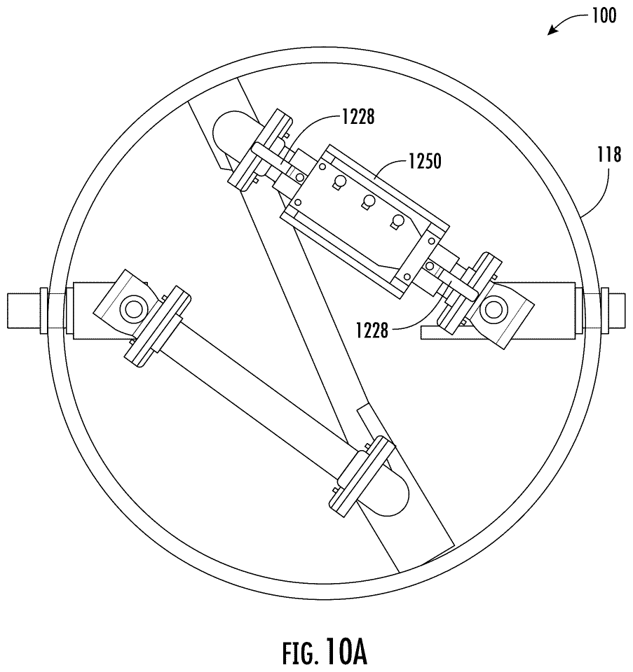

A resetter 901 can be utilized in the meter pit assembly 100 as seen with reference to FIG. 9A. In various aspects, the resetter 901 can be a meter resetter or relocator to change the location and/or orientation of the meter 112. The resetter 901 can be arranged in the system in place of the jumper 702 in various aspects. The resetter 901 can comprise a first coupling interface 911 and a second coupling interface 912 that can connect within the meter pit assembly 100. The quick connect 232 can be integrated into the resetter 901. The quick connect 232 can serve as a sampling port. In various aspects, various portions of the meter pit assembly 100 can be integrated with the resetter 901. With reference to FIG. 9B, the, a valve 1228 can be integrated with the resetter 901. The valve 1228 can be a ball valve in various aspects or any other valve known in the art.

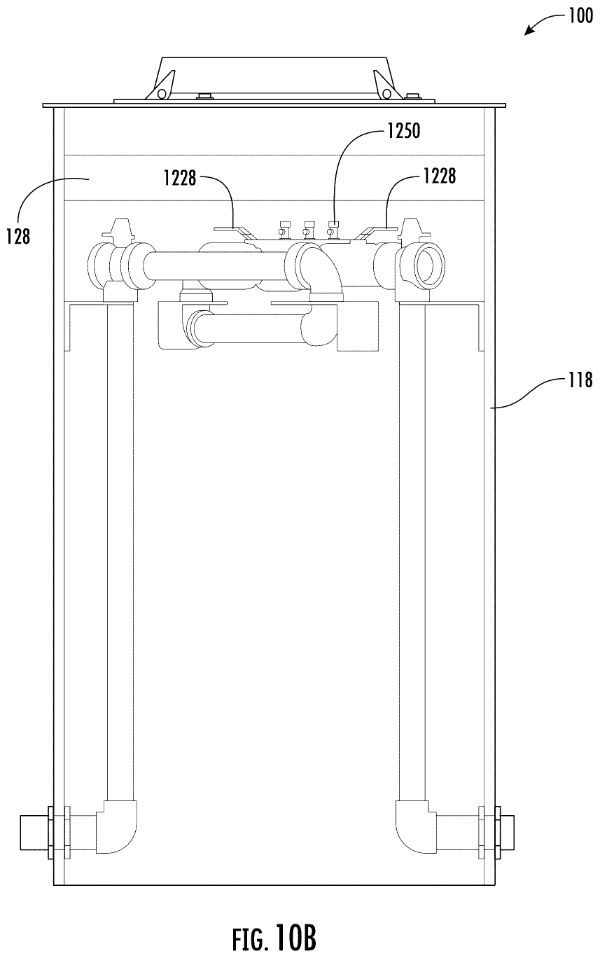

A backflow preventer 1250 can be utilized with the meter pit assembly 100 as seen with reference to FIGS. 10A-10B. The meter pit assembly 100 can comprise at least one valve 1228. In various aspects, the backflow preventer 1250 can be a Zurn Wilkins 350XL. Other suitable backflow prevention systems can be utilized and would be understood by one of skill in the art to be within the scope of the current disclosure.

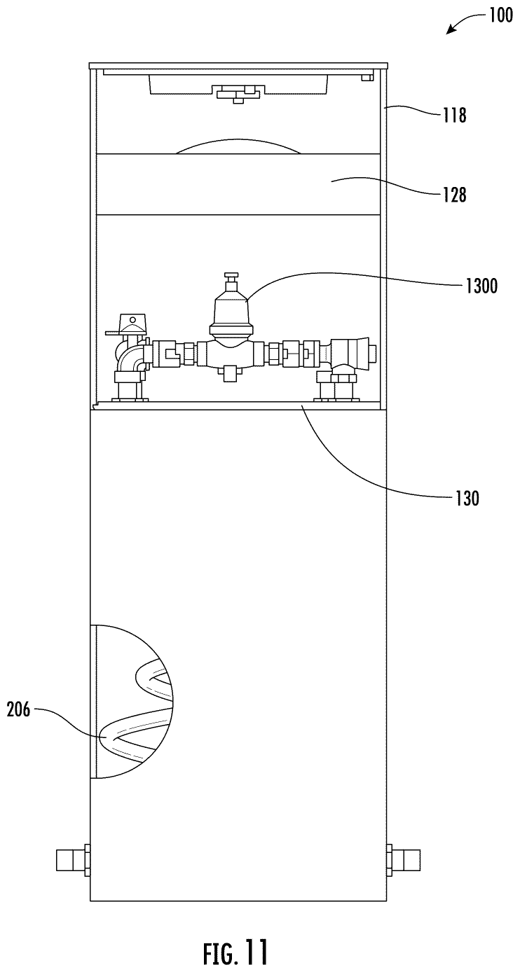

As seen with reference to FIG. 11, a pressure reducing valve 1300 can be integrated into the meter pit assembly 100. The pressure reducing valve 1300 can be a Singer DA140. Other suitable pressure reducing valves can be utilized and would be understood by one of skill in the art to be within the scope of the current disclosure.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A meter pit assembly comprising:
a utility connection;
a ball valve in fluid communication with the utility connection;
a sample port comprising a quick connect fitting in fluid communication with the utility connection;
a logger electronically coupled to a sensor, the sensor in fluid communication with the utility connection; and
a coil in fluid communication with the utility connection, the coil configured to relocate a meter from a lowered position to a raised position.

2. The meter pit assembly of claim 1, wherein the logger is wirelessly electronically coupled to a pressure transducer and a temperature sensor through a wireless network.

3. The meter pit assembly of claim 1, wherein in the raised position the meter is locked relative to the meter pit assembly.

4. The meter pit assembly of claim 1, wherein the meter pit assembly further comprises a canister check valve.

5. The meter pit assembly of claim 1, wherein the sensor is selected from at least one of a pressure transducer, a temperature sensor, and a flow meter electronically coupled to the logger.

6. The meter pit assembly of claim 1, wherein the utility connection comprises the meter coupled between an inlet utility connection and an outlet utility connection.

7. The meter pit assembly of claim 1, wherein the coil is flexible and configured to flex between a relaxed lowered position and an elongated raised position.

8. The meter pit assembly of claim 1, further comprising a sidewall surrounding the utility connection, the ball valve, the logger, the sample port, and the coil, the sidewall supporting a lid.

9. The meter pit assembly of claim 8, wherein the lid defines a sampling void.

10. A meter pit assembly comprising:
a sidewall, the sidewall serving as an enclosure;
a utility connection arranged proximate to the sidewall and being in fluid communication with a flow pathway;
a ball valve in fluid communication with the flow pathway;
a check valve in fluid communication with the flow pathway;
a logger electronically coupled to a sensor, the sensor in fluid communication with the flow pathway; and
a sample port comprising a quick connect fitting, the sample port being in fluid communication with the flow pathway,
wherein the ball valve, the check valve, the logger, and the sample port are enclosed within an interior of the sidewall.

11. The meter pit assembly of claim 10, further comprising a flow meter electronically coupled to the logger and enclosed within the interior of the sidewall.

12. The meter pit assembly of claim 10, wherein the meter pit assembly is rigidly installed with one or more mounting brackets.

13. The meter pit assembly of claim 12, wherein each mounting bracket is connected to the sidewall.

14. The meter pit assembly of claim 10, wherein the sensor is selected from the group comprising a pressure transducer, a hydrophone, a temperature sensor, and a flow meter.

15. The meter pit assembly of claim 10, wherein the meter pit assembly is configured to be adjustably secured between a lowered position and a raised and locked position.

16. The meter pit assembly of claim 10, wherein the meter pit assembly comprises a jumper that is interchangeable with a meter, and the logger is configured to monitor a parameter when the meter is installed in the meter pit assembly.

17. The meter pit assembly of claim 10, wherein the utility connection comprises an inlet utility connection and an outlet utility connection, and wherein the inlet utility connection is coupled to the sidewall with a first hex nut and the outlet utility connection is coupled to the sidewall with a second hex nut.

18. A method of collecting data from a meter pit assembly comprising:
installing a meter pit assembly comprising a ball valve, a sensor electronically coupled to a logger, and a sample port comprising a quick connect fitting;
measuring a parameter of a working fluid, comprising at least one of a pressure, a temperature, and a flow rate of the working fluid; and
electronically transmitting the parameter to a network monitoring the meter pit assembly.

19. The meter pit assembly of claim 18, wherein the parameter is transmitted wirelessly, and the logger is an independent battery-powered standalone unit.

20. The meter pit assembly of claim 18, wherein installing the meter pit assembly comprises installing a sidewall of a pit housing in ground, coupling the sidewall to a lid support and a lid.
